(19) United States
(12) Patent Application Publication
(10) Pub. No.: US 2012/0186188 A1
(43) Pub. Date: Jul. 26, 2012

(54) TAPE AND METHOD FOR MARKING OUT AN EVENT SPACE

(76) Inventor: Lawrence Edinger, Westwood, NJ (US)

(21) Appl. No.: 13/013,312

(22) Filed: Jan. 25, 2011

(51) Int. Cl. E04B 1/35; E04B 2/74; G01B 3/10

(52) U.S. Cl. 52/745.13; 33/562

(57) ABSTRACT

A tape for marking out an event space includes an elongated paper base having a first side and an opposed second side, an adhesive applied to the first side of the base, the adhesive providing a level of adhesion that removably adheres the tape to a concrete floor and leaves no substantial residue upon removal, a plurality of markings visible on the second side of the tape, the markings indicating ten-foot increments, the tape being substantially free of markings between each of the markings indicating the ten-foot increments, and a plurality of fiberglass fibers extending along the length of the paper base, the plurality of fibers being configured to maintain the ten-foot increment between adjacent markings

### FIELD OF THE INVENTION

The present invention relates to a pre-marked tape and a method for marking out an event space using the pre-marked tape.

### BACKGROUND

Large conventions, such as trade shows for example, are often held in large event spaces, e.g., convention centers, that have a very large open area or areas. Typically, an exhibitor may reserve a space dimensioned as a 10 foot by 10 foot square increments. For example, the exhibitor may reserve a single 10 foot by 10 foot space to set up a booth or other exhibition arrangement. Where additional space is needed, the exhibitor may reserve a space made up of multiple, typically adjacent, 10 foot by 10 foot square increments. For example, the exhibitor may reserve two adjacent spaces to have a total space of 10 feet by 20 feet. In this regard, the exhibitor may reserve any appropriate number of spaces (arranged in any appropriate geometry, e.g., a line, L-shape, rectangular grid, or any other arrangement, including irregular arrangements of adjacent spaces. Since the large open floor space of the event center is initially unmarked, event coordinators must mark and divide out the individual spaces or booths reserved by the exhibitors. After the event has concluded, the event coordinators must leave the event floor in its original, unmarked condition.

Known methods of marking out an event space floor involve at least three steps, including; a) applying a masking tape; b) pulling a tape measure; and c) marking the tape (e.g., with pens, shoe polish, or spray chalk) at desired locations measured with the tape measure. This multistep procedure is inefficient and increases the likelihood of human error. Since the event spaces tend to be large, these inefficiencies contribute substantially to the costs of setting up the space, especially in areas where the workers marking the space demand high wages.

Thus, there is a need for an apparatus and method that allow for marking out an event space in a more efficient manner while reducing the potential for user error. Further, there is a need for an apparatus and method that allow for marking out an event space that allows for a single-step process to replace the three-step process described above, white providing accurately dimensioned booth spaces and being easily removed at the conclusion of the event.

### SUMMARY

Example embodiments of the present invention provide a tape and method that allow for simplified, reliable, and efficient marking out of event floor spaces.

In accordance with example embodiments of the present invention, a tape for marking out an event space comprises: an elongated paper base having a first side and an opposed second side; an adhesive applied to the first side of the base, the adhesive providing a level of adhesion that removably adheres the tape to a concrete floor and leaves no substantial residue upon removal; a plurality of markings visible on the second side of the tape, the markings indicating ten-foot increments, the tape being substantially free of markings between each of the markings indicating the ten-foot increments; and a plurality of fiberglass fibers extending along the length of the paper base, the plurality of fibers being configured to maintain the ten-foot increment between adjacent markings. The fibers are provided in the tape to prevent or limit stretching or tearing. In this regard stretching is undesirable during printing and when installing an event setup. With regard to printing, stretching of the tape would cause substantial difficulty in printing the markings at accurate 10 foot increments, e.g., using a drum roller. Regarding event setup and installation, if the tape is stretched, the 10 foot marking would be off. This would result from the markings being printed at 10 increments on the unstretched tape, with subsequent stretching cause the markings to substantially exceed 10 foot increments. Further, the tearing would be a problem if the tape tears during installation or during printing.

The tape may include any suitable number of fiberglass fibers. For example, the tape may include seven or more fiberglass fibers extending along the length of the paper base. Further, each of the fiberglass fibers extends along the entire length of the tape.

The tape may have any desirable continuous length. For example, the tape may have a length of at least 200 feet, and preferably at least 300 feet.

Moreover, the tape may be any suitable width. For example, the tape is ½ inch or less in width, and preferably ¼ inch or less in width.

The tape may be wrapped onto a dowel or other suitable structure.

The plurality of markings may be formed by being printed onto the second side of the paper base, or any other suitable mechanism.

Each of the plurality of markings may extend any suitable length, e.g., ⅛ inch or less, along the length of the tape.

In accordance with example embodiments of the present invention, a method for using example tapes of the present invention comprises: providing measured indications along a first side of an event space, the indications corresponding to the locations boundaries between intended aisles and intended spaces to be occupied by event booths; applying parallel lines of the tape of claim 1 to a floor of the event space such that each line of tape is disposed at a location corresponding to a respective indication along the first side of the event space; and erecting booth dividers at predetermined locations corresponding to respective markings on the tape such that the spacing between adjacent dividers is an increment of ten feet or a multiple thereof.

The erecting may include providing a post at a location corresponding to the respective markings where each divider is erected, each divider being coupled to and vertically supported by the respective divider.

The method may also include, for each of the parallel lines of tape, aligning one of the markings of the respective line of tape with the first side of the event space.

Further features and aspects of example embodiments of the present invention are described in more detail below with reference to the appended Figures. Additional specific embodiments, aspects and advantages of the present invention are also yielded independently of their combination in claims, without restriction of the generality of exemplary embodiments of the present invention shown below with the aid of the drawings.

### BRIEF DESCRIPTION OF THE DRAWINGS

FIG. 1 is a perspective view of a roll of floor-marking tape in accordance with an example embodiment of the present invention.

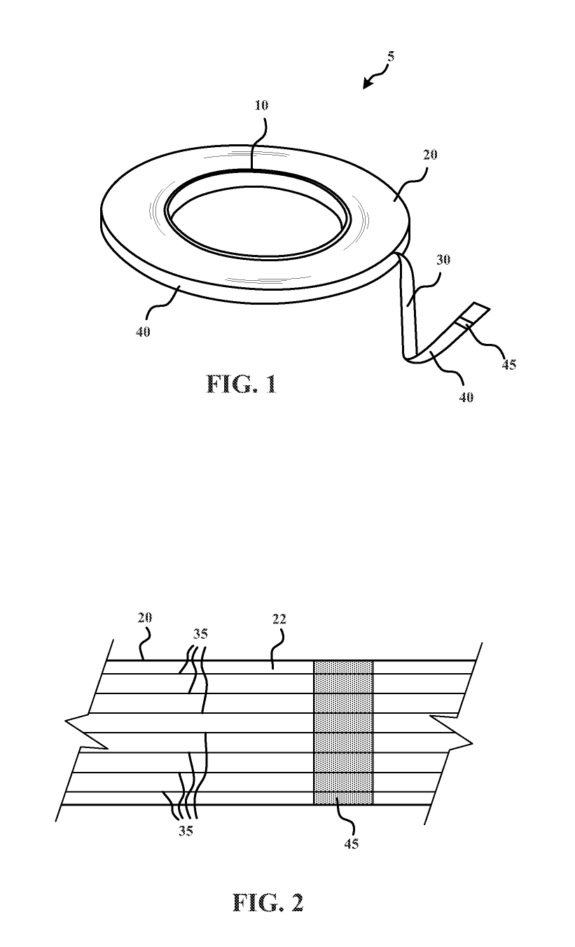

FIG. 2 is a partial view of a first side of the tape of FIG. 1.

FIG. 3 is perspective view of a roll of floor-marking tape in accordance with an example embodiment of the present invention.

FIG. 4 is a perspective view of the roll of floor-marking tape of FIG. 3 white being unrolled and applied to a floor.

FIG. 5 is a perspective view of floor posts installed at the locations of indication markings of the applied tape of FIG. 4.

FIG. 6 is a booth arrangement installed in using the tape of FIG. 3 using a method in accordance with an example embodiment of the present invention.

FIGS. 7 to 10 schematically illustrate the setting up of an event space in accordance with an example embodiment of the present invention.

### DETAILED DESCRIPTION

Referring now to the drawings in detail, wherein like reference characters indicate like parts throughout the several figures, the reference numeral 5 indicates generally a roll 5 of floor-marking tape 20 in accordance with an example embodiment of the present invention.

The tape 120 is wound around an inside dowel 10 such that a first surface or side 30 of the tape 20 faces radially inwardly toward the dowel 10 and a second surface or side 40 of the tape 20 faces radially outwardly away from the dowel 10.

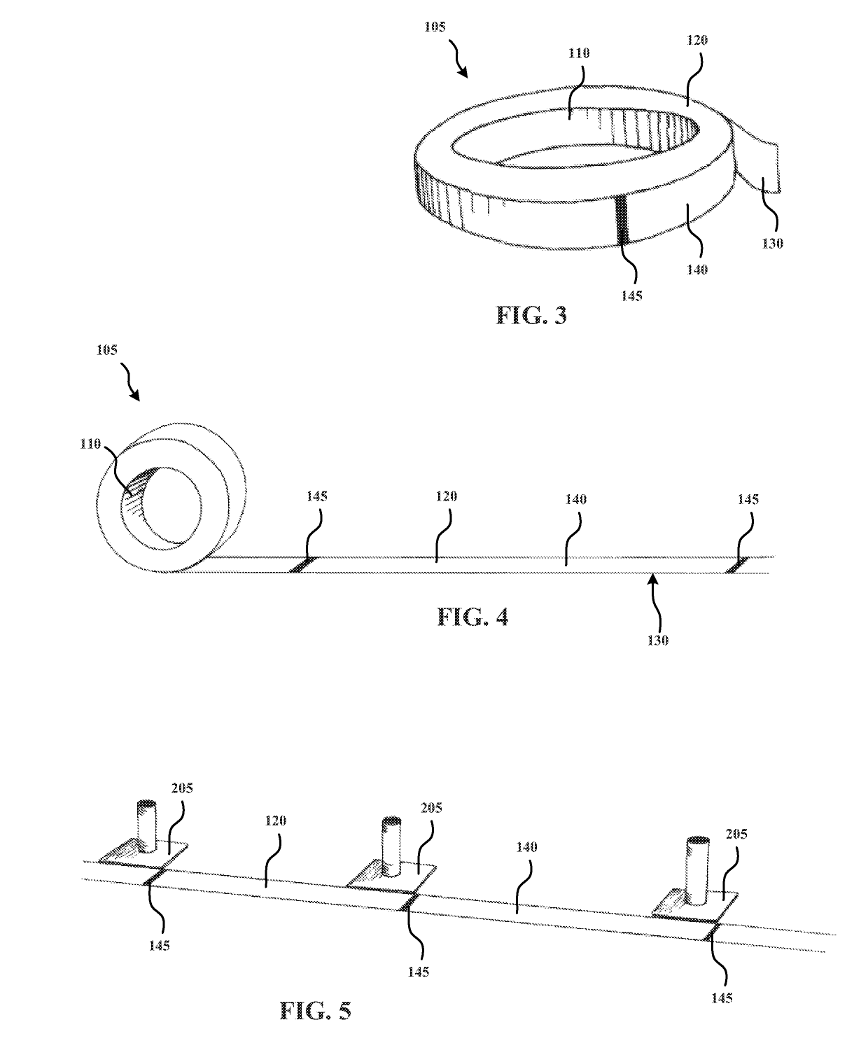

Referring to FIG. 2, the tape 20 has a ¼-inch width paper tape base 22 with fiberglass reinforcement fibers 35 extending longitudinally along the entire length, or substantially the entire length, of the tape 20 on the roll 5. Although five reinforcement fibers 35 extend along the length of the tape 20, it should be understood that more or fewer fibers 35 may be provided depending, for example, on the particular design requirements. The paper base 22 and the dowel 10 may be formed from, e.g., recycled materials.

The first side 30 of the paper base 22 of the tape 20 has a low-tack adhesive applied thereto. The adhesive is selected to sufficiently maintain the tape 20 in its applied position on a surface (e.g., exposed or painted concrete), yet allow the tape 20 to be removed (e.g., by manually pulling and peeling the tape 20 upwardly from the floor) without leaving any residue in both summer and winter temperatures.

The second side of the tape includes a plurality of indication marks 45 equally spaced along the length of the tape 20 in ten-foot increments. The indication marks 45 may have any appropriate length, e.g., ⅛-inch. Although the example marks 45 are provided as red printed lines that extend across the entire width of the tape 20, it should be understood that any suitable mark may be provided. Preferably, the tape is substantially free of any other indication markings between adjacent marks 45 in order to reduce the possibility of user error.

The fiberglass-reinforced paper structure allows the tape 20 to be pulled without substantial stretching and without breaking. In this regard, the tape 20 may have a slight amount of stretch when pulled with sufficient force, but pull back to its original length upon reduction or elimination of the pulling force. For example, for a 200 foot length of tape, the tape may have an elastic range of 6 inches or less of elongation in accordance with example embodiments of the present invention. This limited elasticity allows the tape to be very strong, yet maintain its dimensional stability. Further, the level of tack of the adhesive may be selected such that the force required to provide the slight stretching is greater than the force provided by the adhesion of the tape to the floor surface. In this manner, it may be ensured that the installer does not apply the tape to the floor in a stretched state.

The marks 20 may be applied to the tape base 22 in any suitable manner, e.g., printing. However, it is preferred that the dimensional tolerance between adjacent marks 45 and/or marks at opposite ends of the roll 5 is minimized. Otherwise, substantial dimensional errors may occur, especially for longer spans of tape 20.

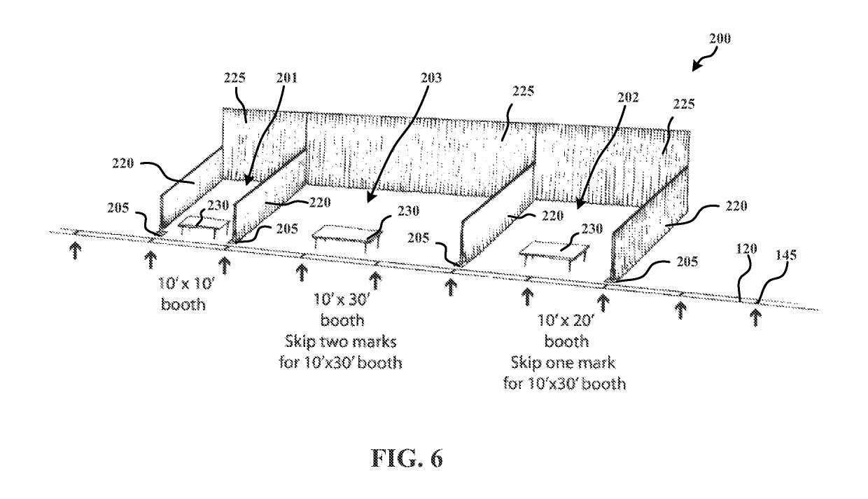

FIG. 3 is perspective view of a roll 105 of floor-marking tape 120 in accordance with an example embodiment of the present invention. Tape roll 105 includes the features of the roll 5 described above, but differs only in that the width of the tape roll 105 is greater. Further, it should be understood that the rolls 5 and 105 are interchangeable with respect to any features or applications described herein, unless specifically indicated otherwise. Generally, the features of the roll 5 described above with any references numbers 1 to 99 correspond to features of the roll 105 having respective reference numbers 101 to 199. For example, the tape 120 of roll 105 corresponds to the tape 20 of roll 5.

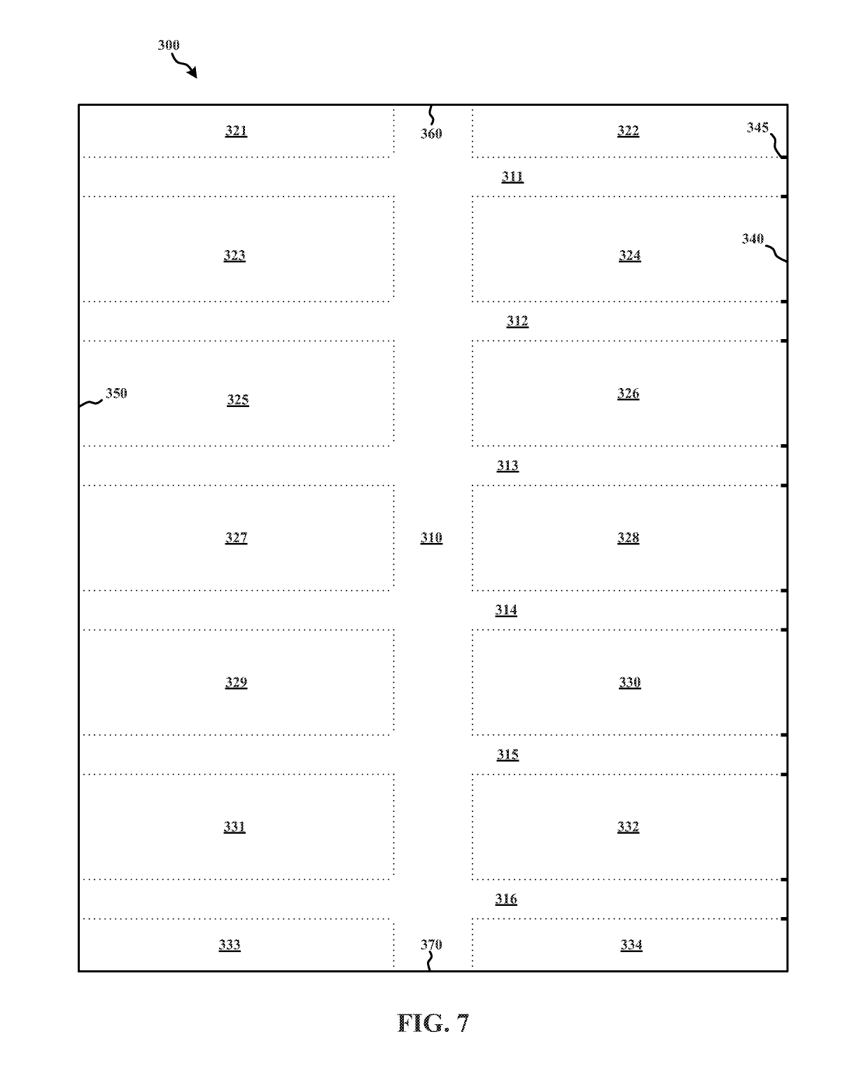

Referring to FIG. 4, the tape roll 105 is shown as being unrolled and applied to a floor. In this regard, the installer would initially ensure that the tape is properly aligned with a frame of reference so that the increments fall in their intended predetermined locations. For example, the installer may align a marking 145 on or near the free end of the roll 105 with a reference location, e.g., a wall, aisle boundary or other reference location. The tape 120 is then unrolled from the roll 110 by the installer pulling the roll in the direction of application. Upon getting the tape 120 into a relatively straight orientation (e.g., by tautening), the installer couples the adhesive surface 1030 to the event space floor. The tape 120 may be cut at or near the last increment mark 145 utilized in the particular run of tape 120.

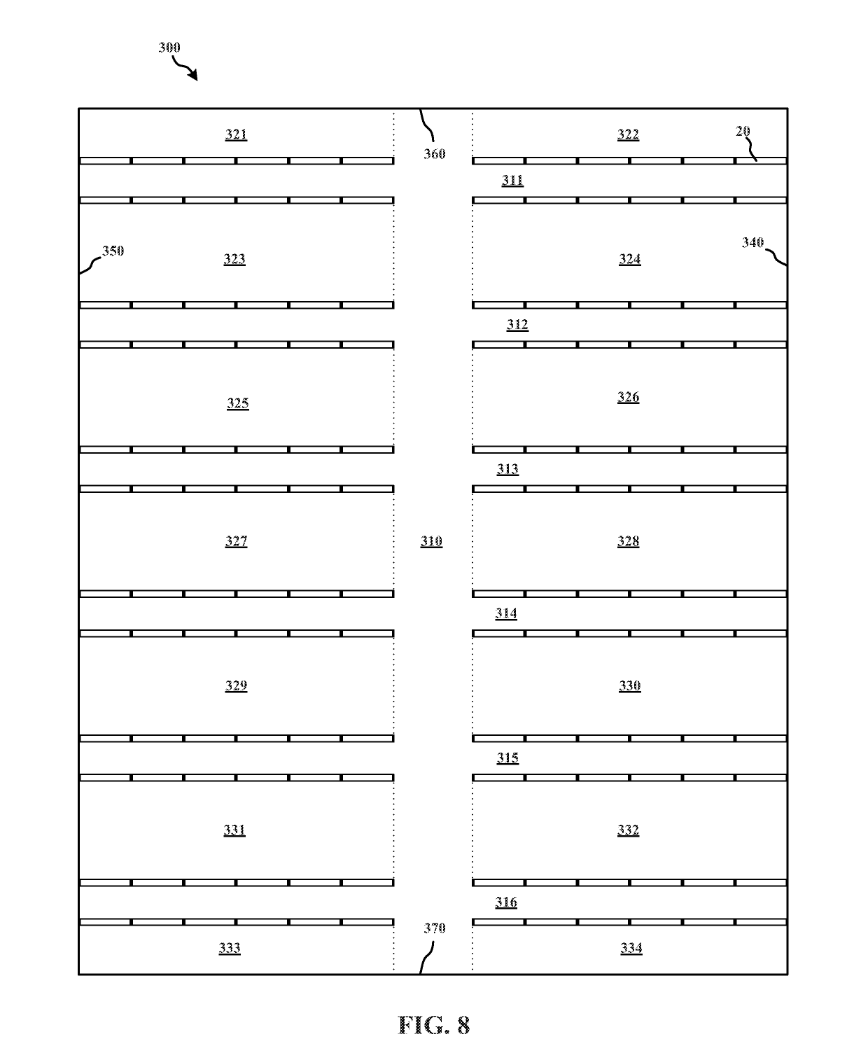

As illustrated in FIG. 4, the increment marks 145 are upwardly exposed and visible when the tape 120 is installed. Referring to FIG. 5, posts 205 may be installed based on the incremental indicator mark 145. The schematic illustration of FIG. 5 shows a post 205 installed at each indicator mark 145, which is suitable for ten-foot booths.

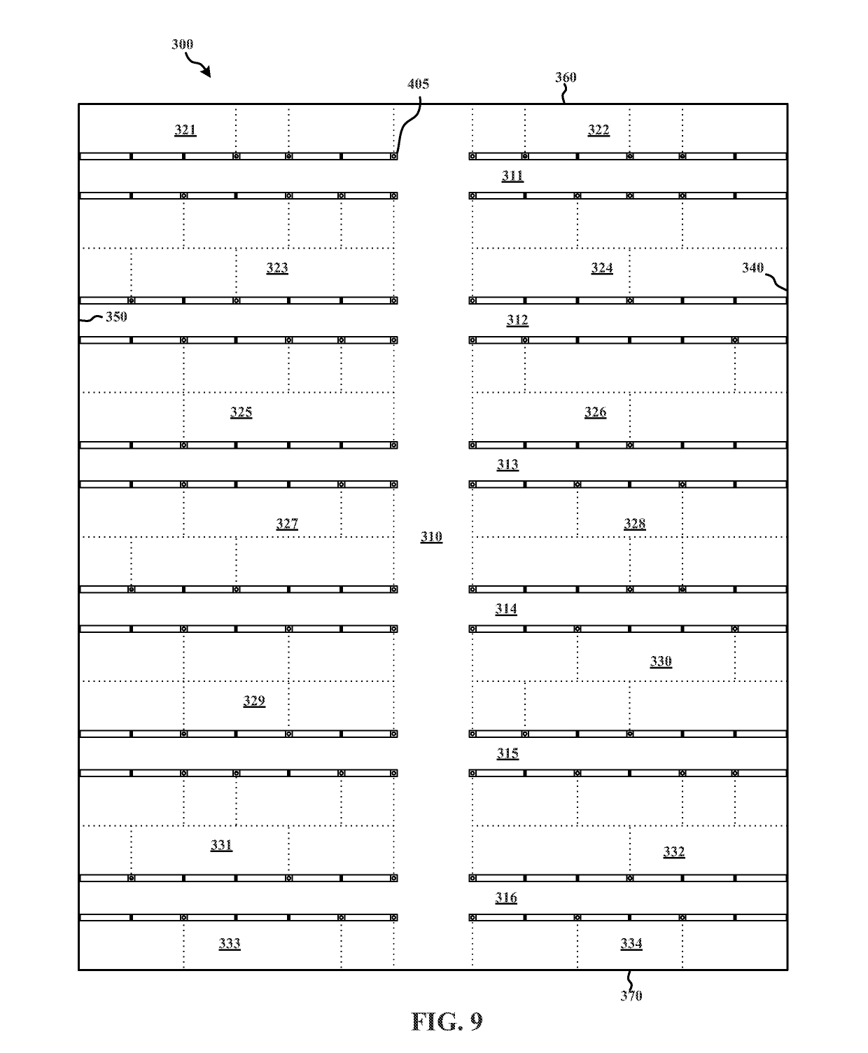

FIG. 6, however, shows posts 205 having different numbers of increments therebetween in a booth arrangement 200. In FIG. 6, the increment indication marks 145 are highlighted by the series of upwardly directed reference arrows pointing to the locations on the tape 120 where the indication marks 145 are respectively located.

As illustrated in FIG. 6, a plurality of booth walls or partitions 220 are mounted on posts 205 and laterally separate and define three booths 201, 202, and 203. The walls may each be supported on their back or opposite end by a second post installed in accordance with another run of tape 120.

The first booth is laterally bound by walls 220 and posts 205 disposed at adjacent increment indicator marks 145. Thus, the watts 220 laterally bounding the first booth 201 are separated by a single ten-foot increment, which leads to the desired ten-foot booth arrangement for booth 201. One of the watts 220 separates the booth 201 from the adjacent booth 203. For the booth 203, the installer would may three increment indication marks from the location of the post 205 and wall 220 separating booths 201 and 203 to determine the location for the post 205 and wall 220 at the opposed lateral end of the booth 203. Accordingly, the three ten-foot increments between adjacent walls 220 lead to a thirty-foot booth 202. In like manner, the installer may count off two ten-foot increments from the edge of booth 203 in order to properly set up the twenty-foot booth 202. It should be understood that any suitable booth arrangement may be provided in accordance with example embodiments of the present invention.

Each booth 201, 202, 203 as a back wall or partition 225 that spans from the respective first partition 220 to the respective second partition 220 bounding each booth 201, 202, 203, such that each booth is U-shaped with one open side. Each booth 201, 202, 203 has also been provided a table 230 to allow presentation during a show on the event floor. In this regard, the tape 120 is disposed along and parallel to an aisle that is adjacent the open end of each booth 201, 202, 203, thereby allowing event attendees to view and access the booths 201, 202, 203 from the walking aisle. Although the booths 201, 202, 203 each have a single open side, it should be understood that any one or more of the booths may be provided with multiple open sides, e.g., where a booth is at a corner location of intersecting aisles and/or where a booth has aisles on opposed ends thereof.

The rolls 5 and 105 described above initially include 300 feet of tape 20, 420, and therefore have 30 ten-foot increments, which may be defined between, e.g., 31 increment indication marks. It should be understood, however, that any desirable length of tape 20, 420 may be provided.

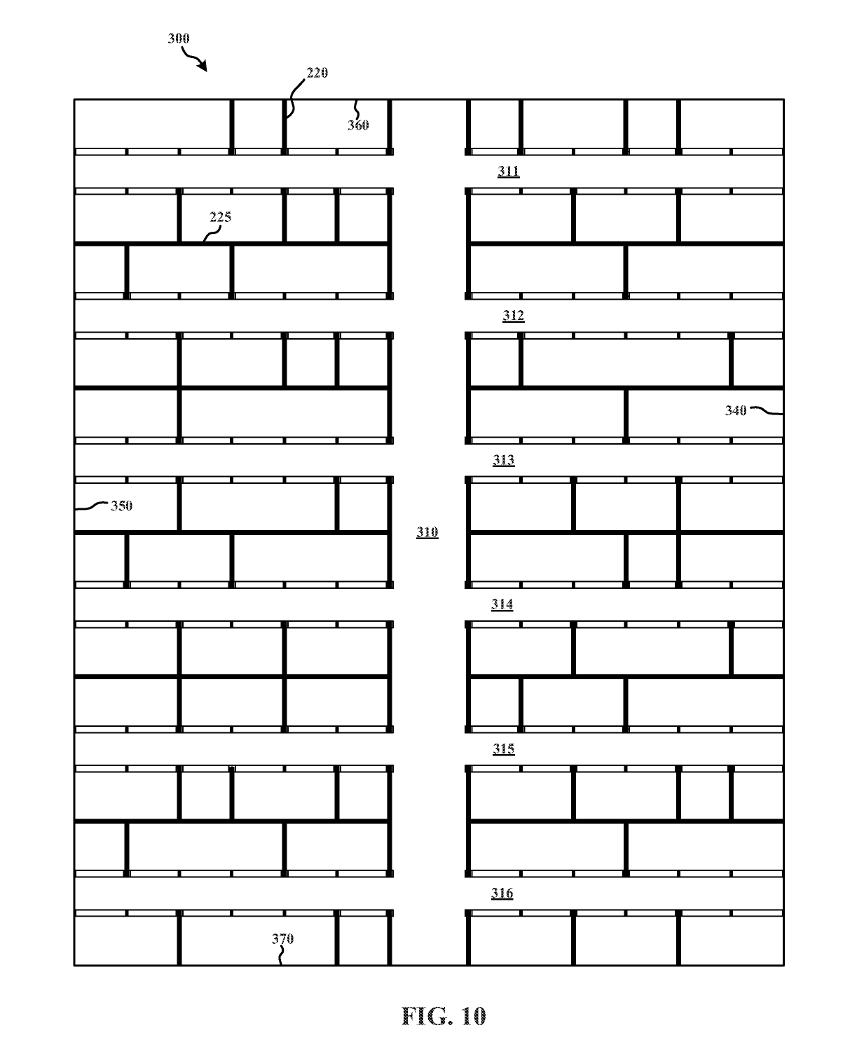

FIG. 5 schematically illustrates an example event space 300, which may correspond to a utilizable floor space of a convention center or other event facility. The broken lines are provided to show the intended locations of booth blocks 321 to 334 and the intended location of aisles 310 to 316, which are intended to extend between the booth blocks 321 to 334. At the stage illustrated in FIG. 5, the floor is unmarked. Thus, the broken lines are indicative of a floor plan to be implemented via a method in accordance with example embodiments of the present invention. In accordance with the floor plan, a main aisle 310 runs the length of the space 300 parallel to the side 340, while transverse aisles 311 to 316 span from a first side 340 to an opposed second side 350. Further, the transverse aisles 311 to 316 run perpendicular to the sides 340 and 350, and perpendicularly intersect the main aisle 310. The main aisle 310 extends from a third side 360 of the event space 300 to an opposed fourth side 370 of the event space 370, the third and fourth sides 360 and 370 extending parallel to each other and perpendicularly to the first and second sides 340 and 350. The first, second, third, and fourth sides, 340, 350, 360, 370, encircle and define the bounds of the event space 300. In this regard, it should be understood that the example arrangement of FIGS. 7 to 10 are merely exemplary and that the size, shape, and configuration of the space may vary in accordance with any desired setup.

As an initial step, the first side 340 of the space 300 is measured and marked with indications 345 at locations corresponding to the boundaries separating the predetermined intended locations of the booth blocks and the predetermined intended locations of the aisles 311 to 316 running transverse to the side 340. This initial measuring and indicating may be performed by using a tape measure and/or using the tape 20, 120 described above (especially where the marks are disposed at ten-foot increments or multiples thereof). Although the indications 345 are markings in the illustrated example, it should be understood that any other form of indication, e.g., a laser illumination, may be provided.

Referring to FIG. 9, the tape 20 is applied from the roll 5 to the floor in parallel lines that each begin at a location on the side 340 of the space 300 corresponding to a respective indication 345 illustrated in FIG. 8. The tape may be initially positioned such that a first indication mark 45 on the tape 20 is aligned with a reference point. For example, the first indication mark 45 may be aligned with the first side 340 of the space 300. It is noted that to facilitate illustration, the tape 20 and other components in FIGS. 7 to 10 are enlarged and not drawn to scale. In this regard, the example tape 20 is actually thin and relatively unnoticeable after the booth installation is completed.

Each line of tape 20 extends parallel to the second and third walls 360 and 370 and falls approximately along the intended boundary between the booth blocks 321 to 324 and the transverse aisles 311 to 316. Since the main aisle 310 of the example arrangement does not have a width that is a ten-foot increment or multiple thereof, each transverse line of tape 20 is broken into two co-linear runs or portions separated by the width of the main aisle 310. The width of the aisle may be measured out from the last indication mark 45 of the first portion of tape 20, and the next indication mark 45 of the tape 20 aligned with the measured location before applying the tape in the direction toward the second wall 350. Further, the second portion of the line may be applied in the direction from second wall 350 toward the first wall 340. In this regard, the second wall 350 may be measured in an analogous manner to the wall 340 described above, or the installer may be able to determine a suitable location along the second wall 350 by eye. The second portion of tape 20 may be aligned such that the first indication mark 45 of the portion of tape 20 remaining on the roll 5 corresponds to the location of the second wall 350. In this manner, any measuring out of the width of the main aisle 310 may be avoided.

Where the main aisle 310 has a width that is a ten-foot increment or a multiple thereof, a single continuous line of tape 20 may extend from the first wall 340 to the second wall 350.

The installation procedure then proceeds in the same general manner as described above with regard to FIGS. 4 to 6. Referring to FIG. 9, in locations where the tape 20 has been applied to the floor of the space 300, posts 205 are positioned at the locations of indication marks 45 corresponding to the predetermined desired location of dividers 220. In FIG. 9, the predetermined intended locations of individual booth spaces are divided by broken lines, e.g., in accordance with a floor plan, and do not represent physical markings on the floor of the space 300. Referring to FIG. 10, in locations where the posts 205 have been positioned, dividers 220 are installed onto the posts 205, which provided a base support for the dividers 220 at respective locations adjacent the transverse aisles 311 to 316. Back walls or partitions 225 are also installed to define the rear boundary of each booth space. For booths extending along the third and fourth sides 360 and 370, the rear boundary may be defined by the third and fourth sides 360 and 370 (e.g., by walls of the third and fourth sides 360 and 370). Likewise, for booths adjacent the first and second sides 340 and 350, the one of the two lateral boundaries may be defined by first and second sides 340 and 350 (e.g., by walls of the first and second sides 340 and 350). However, it should be understood that posts 205 and dividers 220 may be provided along the first and/or second sides 340 and/or 350 at the location of any one or more of the booths disposed adjacent the first and second sides 340 and 350. Likewise, it should be understood that rear dividers 225 may be provided along the third and/or fourth sides 360 and/or 370 at the location of any one or more of the booths disposed adjacent the first and second sides 360 and 370.

It should be understood that the steps described above with regard to FIGS. 7 to 10 need not be performed as discrete steps. That is, one or more of the steps above may be performed during periods where one or more of the other steps are being performed. For example, one or more installers may progress along the first side 340 of the space 300 providing measured indications 345, while another installer begins applying the tape 20 at locations already indicated. Similarly, posts 205 and/or dividers 220 and/or 225 may be placed by one or more installers at locations where tape is installed before the tape 20 is applied in all desired locations and/or before the first installer has finished measuring and providing indications 345 along the first wall 340.

As schematically illustrated in FIG. 10, the event space 300 has been set up with booth spaces, e.g., in accordance with an event floor plan. Display tables 230 and the like and/or any other desired booth contents may then be provided in the individual booths.

The example methods provide advantages in that they, inter alia, dispose with a multiple-step process of taping, measuring, and marking the incremental booth positions. Rather, the example methods, utilizing the example tapes 20, 120, allow these multiple steps to be performed in a single reliably accurate and efficient step.

It is noted that known regular tapes would not be suitable for use in accordance with the example methods set forth above, since they stretch or vary lengthwise. For example, masking tape generally stretches upon application of tensile force and does not return to its non-stretched dimensions upon cessation of the tensile force. Accordingly, such tapes are dimensionally unstable. Over the relatively long distances required in marking out an event space, even a seemingly small percentage of deformation may lead to large inaccuracies with positioning. Further, the example tapes 20, 120 described herein offer further benefits over known tapes in that they include indication 45, 145 specifically adapted for floor space marking and limit any possibility of user error.

Although the present invention has been described with reference to particular examples and exemplary embodiments, it should be understood that the foregoing description is in no manner limiting. Moreover, the features described herein may be used in any combination.

What is claimed is:

1. A tape for marking out an event space, comprising:
an elongated paper base having a first side and an opposed second side;
an adhesive applied to the first side of the base, the adhesive providing a level of adhesion that removably adheres the tape to a concrete floor and leaves no substantial residue upon removal;
a plurality of markings visible on the second side of the tape, the markings indicating ten-foot increments, the tape being substantially free of markings between each of the markings indicating the ten-foot increments; and
a plurality of fiberglass fibers extending along the length of the paper base, the plurality of fibers being configured to maintain the ten-foot increments between adjacent markings.

2. The tape of claim 1, wherein the tape includes seven or more fiberglass fibers extending along the length of the paper base.

3. The tape of claim 1, wherein each of the fiberglass fibers extends along the entire length of the tape.

4. The tape of claim 3, wherein the tape has a continuous length of at least 200 feet.

5. The tape of claim 3, wherein the tape has a length of at least 300 feet.

6. The tape of claim 3, wherein the tape is ½ inch or less in width.

7. The tape of claim 3, wherein the tape is ¼ inch or less in width.

8. The tape of claim 7, wherein the tape includes seven or more fiberglass fibers extending along the length of the paper base.

9. The tape of claim 7, wherein the tape is wrapped onto a dowel.

10. The tape of claim 1, wherein the plurality of markings are printed onto the second side of the paper base.

11. The tape of claim 1, wherein the each of the plurality of markings extends ⅛ inch or less along the length of the tape.

12. A method for using the tape of claim 1, comprising:
providing measured indications along a first side of an event space, the indications corresponding to the locations boundaries between intended aisles and intended spaces to be occupied by event booths;
applying parallel lines of the tape of claim 1 to a floor of the event space such that each line of tape is disposed at a location corresponding to a respective indication along the first side of the event space; and
erecting booth dividers at predetermined locations corresponding to respective markings on the tape such that the spacing between adjacent dividers is an increment of ten feet or a multiple thereof.

13. The method of claim 12, wherein the erecting includes providing a post at a location corresponding to the respective markings where each divider is erected, each divider being coupled to and vertically supported by the respective divider.

14. The method of claim 12, further comprising, for each of the parallel lines of tape, aligning one of the markings of the respective line of tape with the first side of the event space.
